(19) United States
(12) Patent Application Publication
(10) Pub. No.: US 2026/0267886 A1
(43) Pub. Date: Sep. 10, 2026

(54) SYSTEM

(71) Applicant: SoftBank Group Corp., Tokyo (JP)

(72) Inventor: Tsuyoshi MIYACHI, Tokyo (JP)

(21) Appl. No.: 19/073,224

(22) Filed: Mar. 7, 2025

(51) Int. Cl. G06F 16/334; G06F 40/186

(52) U.S. Cl. CPC G06F 16/334; G06F 40/186

(57) ABSTRACT

The system according to the embodiment comprises an input unit, a creation unit, an analysis unit, a generation unit, and a provision unit. The input unit inputs data. The creation unit creates documents based on the data input by the input unit. The analysis unit analyzes numerical values based on the documents created by the creation unit. The generation unit generates responses to inquiries based on the analysis results obtained by the analysis unit. The provision unit provides the responses generated by the generation unit.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, tasks such as document creation, numerical analysis, and inquiry responses are performed manually, resulting in low efficiency and room for improvement.

### SUMMARY OF THE INVENTION

The system according to the embodiment comprises an input unit, a creation unit, an analysis unit, a generation unit, and a provision unit. The input unit inputs data. The creation unit creates documents based on the data input by the input unit. The analysis unit analyzes numerical values based on the documents created by the creation unit. The generation unit generates responses to inquiries based on the analysis results obtained by the analysis unit. The provision unit provides the responses generated by the generation unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor with a sign (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) with a sign is a memory where information is temporarily stored and used as a work memory by the processor.

In the following embodiments, a storage with a sign is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) with a sign is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

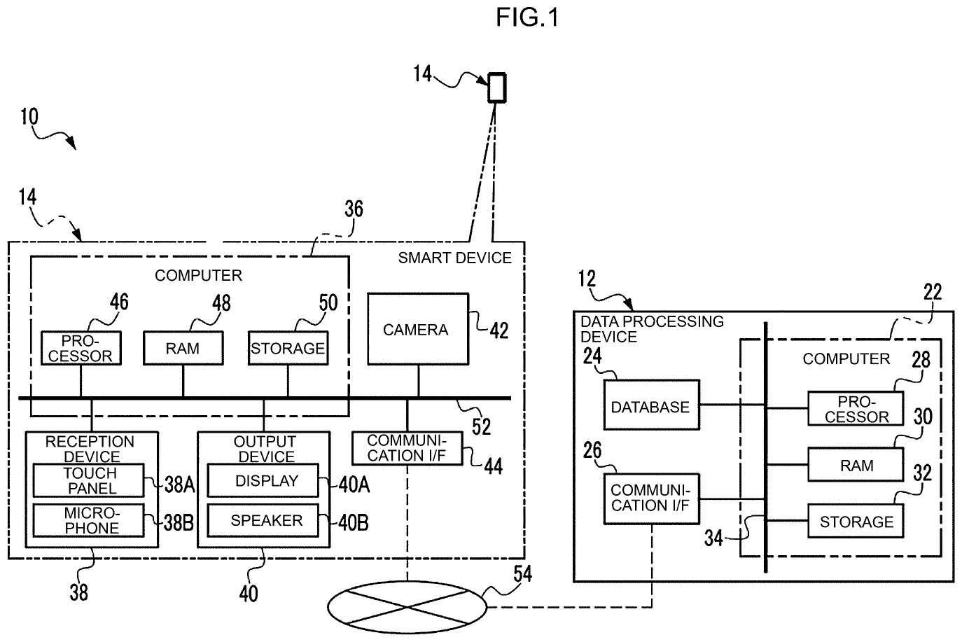

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

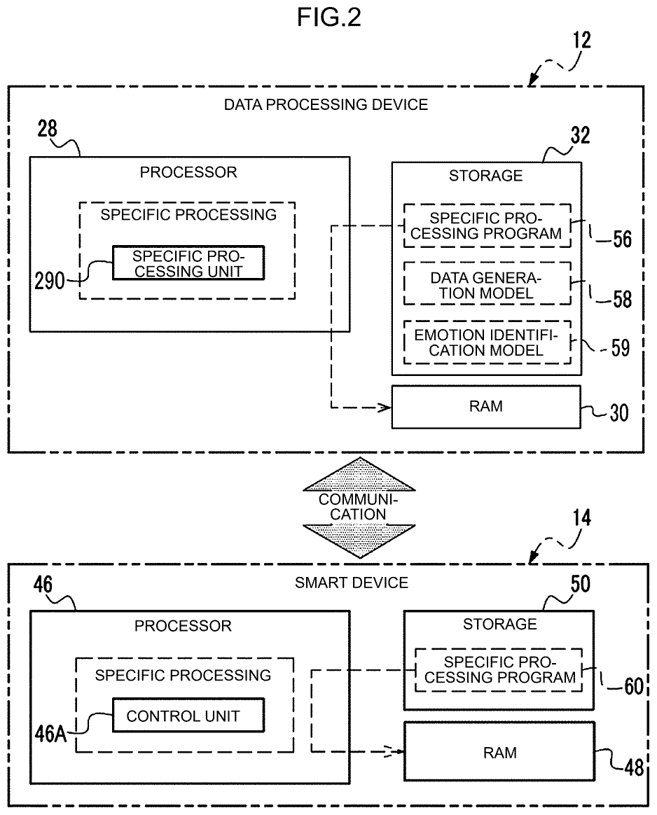

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1 of the Embodiment

The office work efficiency system according to the embodiment utilizes generation AI to automatically perform tasks such as document creation, numerical analysis, and inquiry responses using PowerPoint, Excel, and Gmail. This system can take over the tasks of partner sales, allowing for the reduction or reassignment of sales personnel, leading to revenue improvement and investment in new businesses. For example, the generation AI creates documents using PowerPoint or Excel. The generation AI selects appropriate layouts and designs based on the input data to create visually comprehensible documents. Next, the generation AI performs numerical analysis. The generation AI analyzes sales data and customer data to extract trends and patterns. The generation AI uses complex formulas and statistical methods to analyze the data and outputs the results as graphs or charts. Furthermore, the generation AI responds to inquiries about business content. The generation AI generates quick and accurate responses to inquiries about product specifications and prices based on a pre-learned database. This mechanism allows for the efficiency of partner sales tasks, enabling the reduction or reassignment of sales personnel. This allows companies to improve revenue and allocate freed resources to invest in new businesses. Additionally, since humans are specialized in generating new ideas based on data, it is possible to divide tasks between generation AI and humans. This allows the office work efficiency system to significantly improve business efficiency and achieve revenue improvement and investment in new businesses.

The office work efficiency improvement system according to the embodiment includes a reception unit, a creation unit, an analysis unit, a generation unit, and a provision unit. The reception unit inputs data. Such data includes, but is not limited to, for example, text data, numeric data, and image data. The reception unit inputs data using, for example, presentation tools or spreadsheet tools. The presentation tools include, for example, Microsoft® PowerPoint and Google® Slides. Spreadsheet tools include, for example, Microsoft Excel and Google Sheets.

The creation unit creates materials based on the data input by the reception unit using generative AI. Such materials include, but are not limited to, reports, presentation materials, and analytical reports. The creation unit, for example, selects appropriate layouts and designs based on the input data and creates visually comprehensible materials. The generative AI creates materials using text-generation AI (for example, LLM). Additionally, the creation unit can also generate materials by extracting important portions of the data using generative AI. For example, the generative AI picks up particularly important information within the data using keyword extraction techniques and creates materials based on this information.

The analysis unit analyzes numeric values based on the data input by the reception unit. Such numeric value analyses include, but are not limited to, statistical analysis, regression analysis, and data mining. The analysis unit analyzes, for example, sales data or customer data, and extracts trends or patterns. The analysis unit analyzes data using complex mathematical formulas and statistical methods, and outputs results as graphs or charts.

The generation unit generates answers to inquiries based on the analysis results obtained by the analysis unit. The generation unit generates appropriate answers to inquiries regarding, for example, product specifications or prices, based on a previously learned database. Using generative AI, the generation unit can generate answers rapidly and accurately.

The provision unit provides the answers generated by the generation unit. The provision unit provides, for example, generated answers rapidly and accurately. The provision unit can provide answers using generative AI. For example, the provision unit provides generated answers through web applications or mobile applications.

Thus, the office work efficiency improvement system according to the embodiment can automate operations from data input and material creation to numerical analysis and inquiry response provision, thereby achieving improved operational efficiency.

The input unit inputs data. The data may include, for example, text data, numerical data, image data, etc., but is not limited to these examples. The input unit inputs data using, for example, presentation tools or spreadsheet tools. Presentation tools may include, for example, Microsoft PowerPoint or Google Slides. Spreadsheet tools may include, for example, Microsoft Excel or Google Sheets. The input unit uses these tools to efficiently collect user-input data and incorporate it into the system. Specifically, the input unit automatically extracts the content of slides, graphs, and text boxes created by the user using presentation tools and stores it in a database. Additionally, the input unit analyzes numerical data and formulas input by the user using spreadsheet tools and extracts the necessary information to incorporate it into the system. Furthermore, the input unit can use OCR (Optical Character Recognition) technology to extract text information from scanned documents or image data. This allows paper-based materials and handwritten notes to be incorporated as digital data. The input unit displays the data input status and progress in real-time through a user interface, making it easy for users to confirm and correct the input data. This allows the input unit to streamline the data input process and collect data accurately and quickly.

The creation unit uses generation AI to create documents based on the data input by the input unit. Documents may include, for example, reports, presentation materials, analysis reports, etc., but are not limited to these examples. The creation unit selects appropriate layouts and designs based on the input data to create visually comprehensible documents. The generation AI uses text generation AI (e.g., LLM) to create documents. Additionally, the creation unit can use generation AI to extract important parts of the data and create documents. For example, the generation AI uses keyword extraction technology to pick up particularly important information in the data and create documents based on it. Specifically, the generation AI utilizes natural language processing technology to analyze the input text data, understand the context and meaning, and generate appropriate sentences. Furthermore, the generation AI can automatically create graphs and charts according to the content of the data to visually convey information. For example, in a report based on sales data, the generation AI automatically generates a line graph showing sales trends or a pie chart showing sales by region. Additionally, the generation AI learns the user's preferences and past document creation history to propose layouts and designs more suitable for the user. This allows the creation unit to quickly create high-quality documents without the user having to put in much effort, thereby improving work efficiency.

The analysis unit analyzes numerical values based on the data input by the input unit. Numerical analysis may include, for example, statistical analysis, regression analysis, data mining, etc., but is not limited to these examples. The analysis unit analyzes sales data and customer data to extract trends and patterns. Specifically, the analysis unit uses statistical analysis to calculate basic statistical indicators such as the mean, standard deviation, and variance of the data to understand the distribution and trends of the data. Additionally, the analysis unit uses regression analysis to clarify the relationships between multiple variables, such as the relationship between sales and advertising expenses or the relationship between customer satisfaction and repurchase rate. Furthermore, the analysis unit uses data mining technology to discover useful patterns and rules from large amounts of data to aid business decision-making. For example, the analysis unit analyzes customer data to identify which products are preferred by specific customer segments and uses this information to plan marketing strategies. The analysis unit visually displays these analysis results as graphs or charts to make them intuitively understandable for the user. For example, the analysis unit automatically generates a line graph showing sales trends or a histogram showing the distribution of customer satisfaction. Additionally, the analysis unit can use AI to integrate past data and external data sources to predict future trends and risks. This allows the analysis unit to provide valuable information for understanding the current state of the business and planning future strategies through data analysis.

The generation unit generates responses to inquiries based on the analysis results obtained by the analysis unit. The generation unit generates appropriate responses to inquiries about product specifications and prices based on a pre-learned database. The generation unit can use generation AI to generate responses quickly and accurately. Specifically, the generation AI uses natural language processing technology to analyze the content of inquiries from users and generate appropriate responses. For example, when a user inquires about product specifications, the generation AI searches the product database for relevant information and generates a response in an appropriate format. Additionally, for inquiries about prices, the generation AI provides accurate responses based on the latest price information. Furthermore, the generation unit learns from the user's past inquiry history and the inquiry patterns of other users to provide more appropriate responses. For example, if there have been multiple similar inquiries, the generation AI learns the pattern and can respond quickly to future inquiries. This allows the generation unit to provide quick and accurate responses to user inquiries, thereby improving work efficiency.

The provision unit provides the responses generated by the generation unit. The provision unit provides the generated responses quickly and accurately. The provision unit can also use generation AI to provide responses. For example, the provision unit provides the generated responses through web applications or mobile applications. Specifically, the provision unit displays the generated responses in real-time through web portals or mobile applications accessed by users. Additionally, the provision unit can customize the format and display method of the responses according to the user's preferences. For example, the provision unit can provide not only text-based responses but also visual responses using graphs and charts. Furthermore, the provision unit can collect user feedback to continuously improve the accuracy and provision method of the responses. For example, users can leave evaluations or comments on the provided responses, and the provision unit updates the learning data of the generation AI based on this feedback to improve the accuracy of future responses. This allows the provision unit to provide quick and accurate responses to users, thereby improving work efficiency.

The input unit can input data using a presentation tool or a spreadsheet tool. Presentation tools may include, for example, Microsoft PowerPoint or Google Slides. Spreadsheet tools may include, for example, Microsoft Excel or Google Sheets. The input unit inputs data using, for example, a presentation tool. For example, the input unit can input data in slide format using PowerPoint. Additionally, the input unit can input data using a spreadsheet tool. For example, the input unit can input data in table format using Excel. This improves the efficiency of data input by using presentation tools or spreadsheet tools. Some or all of the aforementioned processes in the input unit may be performed using AI or without using AI. For example, the input unit can input data entered using presentation tools or spreadsheet tools into AI and have the AI perform data analysis and processing.

The creation unit can select an appropriate layout or design based on the input data and create visually comprehensible documents. The creation unit uses generation AI to select an appropriate layout or design based on the input data and create visually comprehensible documents. For example, the creation unit can automate the creation of sales reports or presentation materials. The generation AI selects an appropriate layout or design based on the input data to create visually comprehensible documents. For example, the generation AI extracts important parts of the data and creates documents based on them. The generation AI uses text generation AI (e.g., LLM) to create documents. Additionally, the generation AI can use multimodal generation AI to create the content of documents. For example, the generation AI uses keyword extraction technology to pick up particularly important information in the data and create documents based on it. This allows the automatic creation of visually comprehensible documents, improving the efficiency of document creation. Some or all of the aforementioned processes in the creation unit are performed using generation AI. For example, the creation unit can input the input data into the generation AI and have the generation AI perform document creation.

The analysis unit can analyze sales data or customer data and extract trends or patterns. The analysis unit analyzes sales data or customer data to extract trends or patterns. Sales data may include, for example, monthly sales, sales by product, etc. Customer data may include, for example, customer attribute information, purchase history, etc. The analysis unit analyzes sales data to extract trends or patterns. For example, the analysis unit can analyze sales data to analyze sales increase or decrease trends. Additionally, the analysis unit can analyze customer data to extract trends or patterns. For example, the analysis unit can analyze customer data to analyze customer purchase trends. This allows the automation of sales data or customer data analysis, improving the efficiency of trend or pattern extraction. Some or all of the aforementioned processes in the analysis unit may be performed using AI or without using AI. For example, the analysis unit can input sales data or customer data into AI and have the AI perform data analysis.

The generation unit can generate responses to inquiries about product specifications or prices based on a pre-learned database. The generation unit generates responses to inquiries about product specifications or prices based on a pre-learned database. The pre-learned database may include, for example, machine learning models or training datasets. Product specifications or prices may include, for example, technical specifications or price lists. The generation unit generates responses to inquiries about product specifications based on technical specifications. Additionally, the generation unit can generate responses to inquiries about prices based on price lists. This allows the provision of quick and accurate responses to inquiries about product specifications or prices. Some or all of the aforementioned processes in the generation unit are performed using generation AI. For example, the generation unit can input the pre-learned database into the generation AI and have the generation AI perform the generation of responses to inquiries.

The provision unit can provide the generated responses quickly and accurately. The provision unit provides the generated responses quickly and accurately. Providing quickly and accurately includes, for example, criteria such as response time or error rate. The provision unit provides the generated responses through web applications or mobile applications. For example, the provision unit displays the generated responses on a web application for user access. Additionally, the provision unit can display the generated responses on a mobile application for user access via smartphones or tablets. This improves the efficiency of inquiry response by providing the generated responses quickly and accurately. Some or all of the aforementioned processes in the provision unit may be performed using AI or without using AI. For example, the provision unit can input the generated responses into AI and have the AI perform the provision of responses.

The input unit can analyze the user's past data input history and select an input method. The input unit, for example, preferentially proposes frequently used input methods (voice input, text input, etc.) by the user in the past. Additionally, the input unit can propose the optimal input method for specific time periods based on the user's past data input history. Furthermore, the input unit can propose efficient data input procedures based on the user's past input history. This allows the proposal of the optimal input method by analyzing the user's past data input history, improving the efficiency of data input. Some or all of the aforementioned processes in the input unit may be performed using AI or without using AI. For example, the input unit can input the user's past data input history into AI and have the AI perform the selection of input methods.

The input unit can filter data based on the user's current project or area of interest during data input. The input unit, for example, prioritizes the input of data related to the project the user is currently working on. Additionally, the input unit can filter and input data with high relevance based on the user's area of interest. Furthermore, the input unit can select and input necessary data according to the progress of the user's project. This allows the efficient input of relevant data by filtering data based on the user's current project or area of interest. Some or all of the aforementioned processes in the input unit may be performed using AI or without using AI. For example, the input unit can input data related to the user's current project or area of interest into AI and have the AI perform the filtering.

The input unit can prioritize the input of relevant data based on the user's geographical location during data input. The input unit, for example, prioritizes the input of data related to a specific region when the user is in that region. Additionally, the input unit can input relevant data based on the current location when the user is on the move. Furthermore, the input unit can prioritize the input of data related to a specific place when the user is in that place. This allows the efficient input of relevant data by considering the user's geographical location. Some or all of the aforementioned processes in the input unit may be performed using AI or without using AI. For example, the input unit can input the user's geographical location into AI and have the AI perform the selection of relevant data.

The input unit can input related data based on the user's social media activities during data input. The input unit, for example, inputs related data based on information shared by the user on social media. Additionally, the input unit can input data related to topics of interest based on the user's social media activities. Furthermore, the input unit can analyze the activities of the user's social media followers or friends and input related data. This allows the efficient input of relevant data by analyzing the user's social media activities. Some or all of the aforementioned processes in the input unit may be performed using AI or without using AI. For example, the input unit can input the user's social media activity data into AI and have the AI perform the selection of related data.

The creation unit can adjust the level of detail of documents based on the importance of the data during document creation. The creation unit uses generation AI to adjust the level of detail of documents based on the importance of the data during document creation. For example, the creation unit creates documents with detailed explanations and graphs for highly important data. Additionally, the creation unit can create documents with concise explanations and only key points for less important data. Furthermore, the creation unit can adjust the number of pages and the level of detail of the content of documents according to the importance of the data. This allows efficient document creation by adjusting the level of detail of documents based on the importance of the data. Some or all of the aforementioned processes in the creation unit are performed using generation AI. For example, the creation unit can input the importance of the data into the generation AI and have the generation AI perform the adjustment of the level of detail of documents.

The creation unit can apply different layouts or designs based on the category of the data during document creation. The creation unit uses generation AI to apply different layouts or designs based on the category of the data during document creation. For example, the creation unit applies a layout with many graphs and charts for sales data. Additionally, the creation unit can apply a table format layout for customer data. Furthermore, the creation unit can apply a timeline format layout for project progress data. This allows the creation of visually comprehensible documents by adjusting the layout or design according to the category of the data. Some or all of the aforementioned processes in the creation unit are performed using generation AI. For example, the creation unit can input the category of the data into the generation AI and have the generation AI perform the application of layouts or designs.

The creation unit can determine the priority of documents based on the submission timing of the data during document creation. The creation unit uses generation AI to determine the priority of documents based on the submission timing of the data during document creation. For example, the creation unit prioritizes the creation of documents for data with a close deadline. Additionally, the creation unit can postpone the creation of documents for data with a distant submission timing. Furthermore, the creation unit can adjust the schedule of document creation according to the submission timing. This allows efficient document creation by determining the priority of documents based on the submission timing of the data. Some or all of the aforementioned processes in the creation unit are performed using generation AI. For example, the creation unit can input the submission timing of the data into the generation AI and have the generation AI perform the determination of document priority.

The creation unit can adjust the order of documents based on the relevance of the data during document creation. The creation unit uses generation AI to adjust the order of documents based on the relevance of the data during document creation. For example, the creation unit prioritizes the placement of highly relevant data in the first half of the documents. Additionally, the creation unit can place less relevant data in the latter half of the documents. Furthermore, the creation unit can adjust the chapters or sections of the documents according to the relevance of the data. This allows the creation of visually comprehensible documents by adjusting the order of documents based on the relevance of the data. Some or all of the aforementioned processes in the creation unit are performed using generation AI. For example, the creation unit can input the relevance of the data into the generation AI and have the generation AI perform the adjustment of document order.

The analysis unit can improve the accuracy of analysis based on the interrelationships of the data during analysis. The analysis unit uses AI to improve the accuracy of analysis by considering the interrelationships of the data during analysis. For example, the analysis unit considers the interrelationship between sales data and customer data to extract trends. Additionally, the analysis unit can propose efficient resource allocation by considering the interrelationship between project progress data and resource data. Furthermore, the analysis unit can analyze market trends by considering the interrelationship between product data and market data. This improves the accuracy of analysis by considering the interrelationships of the data. Some or all of the aforementioned processes in the analysis unit may be performed using AI or without using AI. For example, the analysis unit can input the interrelationships of the data into AI and have the AI perform the improvement of analysis accuracy.

The analysis unit can perform analysis based on the geographical distribution of the data during analysis. The analysis unit uses AI to perform analysis by considering the geographical distribution of the data during analysis. For example, the analysis unit considers the geographical distribution of sales data to analyze trends by region. Additionally, the analysis unit can analyze customer characteristics by region by considering the geographical distribution of customer data. Furthermore, the analysis unit can analyze market needs by region by considering the geographical distribution of product data. This allows analysis that reflects regional characteristics by considering the geographical distribution of the data. Some or all of the aforementioned processes in the analysis unit may be performed using AI or without using AI. For example, the analysis unit can input the geographical distribution of the data into AI and have the AI perform the analysis.

The analysis unit can improve the accuracy of analysis by referring to related literature of the data during analysis. The analysis unit uses AI to improve the accuracy of analysis by referring to related literature of the data during analysis. For example, the analysis unit refers to related market research reports during the analysis of sales data. Additionally, the analysis unit can refer to related academic papers during the analysis of customer data. Furthermore, the analysis unit can refer to related technical literature during the analysis of product data. This improves the accuracy of analysis by referring to related literature of the data. Some or all of the aforementioned processes in the analysis unit may be performed using AI or without using AI. For example, the analysis unit can input the related literature of the data into AI and have the AI perform the improvement of analysis accuracy.

The generation unit can generate responses based on past inquiry data during response generation. The generation unit uses AI to generate optimal responses by referring to past inquiry data during response generation. For example, the generation unit generates optimal responses based on past responses when there have been similar inquiries. Additionally, the generation unit can generate responses to frequently asked questions based on past inquiry data. Furthermore, the generation unit can analyze past inquiry data to generate the most effective responses. This allows the quick generation of optimal responses by referring to past inquiry data. Some or all of the aforementioned processes in the generation unit may be performed using AI or without using AI. For example, the generation unit can input past inquiry data into AI and have the AI perform the generation of responses.

The generation unit can apply response algorithms based on the category of the inquiry during response generation. The generation unit uses AI to apply different response algorithms according to the category of the inquiry during response generation. For example, the generation unit applies a response algorithm including technical details for inquiries about product specifications. Additionally, the generation unit can apply a response algorithm including price lists or discount information for inquiries about prices. Furthermore, the generation unit can apply a response algorithm including procedures or FAQs for inquiries about support. This allows the provision of optimal responses according to the category of the inquiry. Some or all of the aforementioned processes in the generation unit may be performed using AI or without using AI. For example, the generation unit can input the category of the inquiry into AI and have the AI perform the application of response algorithms.

The generation unit can determine the priority of responses based on the submission timing of the inquiry during response generation. The generation unit uses AI to determine the priority of responses based on the submission timing of the inquiry during response generation. For example, the generation unit generates responses quickly for urgent inquiries. Additionally, the generation unit can postpone the generation of responses for inquiries with an old submission timing. Furthermore, the generation unit can adjust the schedule of response generation according to the submission timing. This allows quick response by determining the priority of responses based on the submission timing of the inquiry. Some or all of the aforementioned processes in the generation unit may be performed using AI or without using AI. For example, the generation unit can input the submission timing of the inquiry into AI and have the AI perform the determination of response priority.

The generation unit can adjust the order of responses based on the relevance of the inquiry during response generation. The generation unit uses AI to adjust the order of responses based on the relevance of the inquiry during response generation. For example, the generation unit prioritizes the generation of responses for highly relevant inquiries. Additionally, the generation unit can postpone the generation of responses for less relevant inquiries. Furthermore, the generation unit can adjust the order of responses according to the relevance of the inquiry. This allows efficient response provision by adjusting the order of responses based on the relevance of the inquiry. Some or all of the aforementioned processes in the generation unit may be performed using AI or without using AI. For example, the generation unit can input the relevance of the inquiry into AI and have the AI perform the adjustment of response order.

The provision unit can select the method of providing responses based on the user's past inquiry history during response provision. The provision unit uses AI to select the optimal method of providing responses by referring to the user's past inquiry history during response provision. For example, the provision unit preferentially provides the method of provision (email, chat, etc.) that the user has preferred to use in the past. Additionally, the provision unit can select the optimal method of provision based on the user's past inquiry history. Furthermore, the provision unit can select an efficient method of provision based on the user's past inquiry history. This allows the selection of the optimal method of provision by referring to the user's past inquiry history. Some or all of the aforementioned processes in the provision unit may be performed using AI or without using AI. For example, the provision unit can input the user's past inquiry history into AI and have the AI perform the selection of the method of provision.

The provision unit can select the method of providing responses based on the user's device information during response provision. The provision unit uses AI to select the optimal method of providing responses by considering the user's device information during response provision. For example, the provision unit selects a method of provision that matches the screen size when the user is using a smartphone. Additionally, the provision unit can select a method of provision optimized for a large screen when the user is using a tablet. Furthermore, the provision unit can select a method of provision that includes detailed information when the user is using a desktop. This allows the selection of the optimal method of provision by considering the user's device information. Some or all of the aforementioned processes in the provision unit may be performed using AI or without using AI. For example, the provision unit can input the user's device information into AI and have the AI perform the selection of the method of provision.

The system according to the embodiment is not limited to the examples described above and can be modified in various ways, for example, as follows.

The office work efficiency system further comprises a notification unit. The notification unit plays a role in notifying the user of the processing results from the creation unit, analysis unit, or generation unit. For example, when the creation unit completes a document, the notification unit can send a notification to the user via email or chat. Additionally, when the analysis unit discovers a new trend, the notification unit can inform the user of the result in real-time. Furthermore, when the generation unit generates a response to an inquiry, the notification unit can quickly provide the response to the user. This allows the user to receive important information in a timely manner, further improving work efficiency.

The input unit can analyze the user's past data input history and select an input method. For example, the input unit preferentially proposes frequently used input methods (voice input, text input, etc.) by the user in the past. Additionally, the input unit can propose the optimal input method for specific time periods based on the user's past data input history. Furthermore, the input unit can propose efficient data input procedures based on the user's past input history. This allows the proposal of the optimal input method by analyzing the user's past data input history, improving the efficiency of data input.

The creation unit can adjust the level of detail of documents based on the importance of the data during document creation. For example, the creation unit creates documents with detailed explanations and graphs for highly important data. Additionally, the creation unit can create documents with concise explanations and only key points for less important data. Furthermore, the creation unit can adjust the number of pages and the level of detail of the content of documents according to the importance of the data. This allows efficient document creation by adjusting the level of detail of documents based on the importance of the data.

The analysis unit can improve the accuracy of analysis based on the interrelationships of the data during analysis. For example, the analysis unit considers the interrelationship between sales data and customer data to extract trends. Additionally, the analysis unit can propose efficient resource allocation by considering the interrelationship between project progress data and resource data. Furthermore, the analysis unit can analyze market trends by considering the interrelationship between product data and market data. This improves the accuracy of analysis by considering the interrelationships of the data.

The generation unit can generate responses based on past inquiry data during response generation. For example, the generation unit generates optimal responses based on past responses when there have been similar inquiries. Additionally, the generation unit can generate responses to frequently asked questions based on past inquiry data. Furthermore, the generation unit can analyze past inquiry data to generate the most effective responses. This allows the quick generation of optimal responses by referring to past inquiry data.

The following is a brief explanation of the process flow in Example 1 of the Embodiment.

Step 1: The input unit inputs data. The data may include, for example, text data, numerical data, image data, etc. The input unit inputs data using presentation tools (e.g., Microsoft PowerPoint, Google Slides) or spreadsheet tools (e.g., Microsoft Excel, Google Sheets).

Step 2: The creation unit uses generation AI to create documents based on the data input by the input unit. Documents may include reports, presentation materials, analysis reports, etc. The creation unit selects appropriate layouts and designs based on the input data to create visually comprehensible documents. The generation AI uses text generation AI (e.g., LLM) to create documents and can also extract important parts of the data to create documents.

Step 3: The analysis unit analyzes numerical values based on the data input by the input unit. Numerical analysis may include statistical analysis, regression analysis, data mining, etc. The analysis unit analyzes sales data and customer data to extract trends and patterns. The analysis unit uses complex formulas and statistical methods to analyze the data and outputs the results as graphs or charts.

Step 4: The generation unit generates responses to inquiries based on the analysis results obtained by the analysis unit. The generation unit generates appropriate responses to inquiries about product specifications and prices based on a pre-learned database. The generation unit uses generation AI to generate responses quickly and accurately.

Step 5: The provision unit provides the responses generated by the generation unit. The provision unit provides the generated responses quickly and accurately. The provision unit uses generation AI to provide responses through web applications or mobile applications.

### Example 2 of the Embodiment

The office work efficiency system according to the embodiment utilizes generation AI to automatically perform tasks such as document creation, numerical analysis, and inquiry responses using PowerPoint, Excel, and Gmail. This system can take over the tasks of partner sales, allowing for the reduction or reassignment of sales personnel, leading to revenue improvement and investment in new businesses. For example, the generation AI creates documents using PowerPoint or Excel. The generation AI selects appropriate layouts and designs based on the input data to create visually comprehensible documents. Next, the generation AI performs numerical analysis. The generation AI analyzes sales data and customer data to extract trends and patterns. The generation AI uses complex formulas and statistical methods to analyze the data and outputs the results as graphs or charts. Furthermore, the generation AI responds to inquiries about business content. The generation AI generates quick and accurate responses to inquiries about product specifications and prices based on a pre-learned database. This mechanism allows for the efficiency of partner sales tasks, enabling the reduction or reassignment of sales personnel. This allows companies to improve revenue and allocate freed resources to invest in new businesses. Additionally, since humans are specialized in generating new ideas based on data, it is possible to divide tasks between generation AI and humans. This allows the office work efficiency system to significantly improve business efficiency and achieve revenue improvement and investment in new businesses.

The office work efficiency system according to the embodiment comprises an input unit, a creation unit, an analysis unit, a generation unit, and a provision unit. The input unit inputs data. The data may include, for example, text data, numerical data, image data, etc., but is not limited to these examples. The input unit inputs data using, for example, presentation tools or spreadsheet tools. Presentation tools may include, for example, Microsoft PowerPoint or Google Slides. Spreadsheet tools may include, for example, Microsoft Excel or Google Sheets. The creation unit uses generation AI to create documents based on the data input by the input unit. Documents may include, for example, reports, presentation materials, analysis reports, etc., but are not limited to these examples. The creation unit selects appropriate layouts and designs based on the input data to create visually comprehensible documents. The generation AI uses text generation AI (e.g., LLM) to create documents. Additionally, the creation unit can use generation AI to extract important parts of the data and create documents. For example, the generation AI uses keyword extraction technology to pick up particularly important information in the data and create documents based on it. The analysis unit analyzes numerical values based on the data input by the input unit. Numerical analysis may include, for example, statistical analysis, regression analysis, data mining, etc., but is not limited to these examples. The analysis unit analyzes sales data and customer data to extract trends and patterns. The analysis unit uses complex formulas and statistical methods to analyze the data and outputs the results as graphs or charts. The generation unit generates responses to inquiries based on the analysis results obtained by the analysis unit. The generation unit generates appropriate responses to inquiries about product specifications and prices based on a pre-learned database. The generation unit can use generation AI to generate responses quickly and accurately. The provision unit provides the responses generated by the generation unit. The provision unit provides the generated responses quickly and accurately. The provision unit can also use generation AI to provide responses. For example, the provision unit provides the generated responses through web applications or mobile applications. This allows the office work efficiency system according to the embodiment to automate the process from data input to document creation, numerical analysis, and inquiry response provision, thereby improving work efficiency.

The input unit inputs data. The data may include, for example, text data, numerical data, image data, etc., but is not limited to these examples. The input unit inputs data using, for example, presentation tools or spreadsheet tools. Presentation tools may include, for example, Microsoft PowerPoint or Google Slides. Spreadsheet tools may include, for example, Microsoft Excel or Google Sheets. The input unit uses these tools to efficiently collect user-input data and incorporate it into the system. Specifically, the input unit automatically extracts the content of slides, graphs, and text boxes created by the user using presentation tools and stores it in a database. Additionally, the input unit analyzes numerical data and formulas input by the user using spreadsheet tools and extracts the necessary information to incorporate it into the system. Furthermore, the input unit can use OCR (Optical Character Recognition) technology to extract text information from scanned documents or image data. This allows paper-based materials and handwritten notes to be incorporated as digital data. The input unit displays the data input status and progress in real-time through a user interface, making it easy for users to confirm and correct the input data. This allows the input unit to streamline the data input process and collect data accurately and quickly.

The creation unit uses generation AI to create documents based on the data input by the input unit. Documents may include, for example, reports, presentation materials, analysis reports, etc., but are not limited to these examples. The creation unit selects appropriate layouts and designs based on the input data to create visually comprehensible documents. The generation AI uses text generation AI (e.g., LLM) to create documents. Additionally, the creation unit can use generation AI to extract important parts of the data and create documents. For example, the generation AI uses keyword extraction technology to pick up particularly important information in the data and create documents based on it. Specifically, the generation AI utilizes natural language processing technology to analyze the input text data, understand the context and meaning, and generate appropriate sentences. Furthermore, the generation AI can automatically create graphs and charts according to the content of the data to visually convey information. For example, in a report based on sales data, the generation AI automatically generates a line graph showing sales trends or a pie chart showing sales by region. Additionally, the generation AI learns the user's preferences and past document creation history to propose layouts and designs more suitable for the user. This allows the creation unit to quickly create high-quality documents without the user having to put in much effort, thereby improving work efficiency.

The analysis unit analyzes numerical values based on the data input by the input unit. Numerical analysis may include, for example, statistical analysis, regression analysis, data mining, etc., but is not limited to these examples. The analysis unit analyzes sales data and customer data to extract trends and patterns. Specifically, the analysis unit uses statistical analysis to calculate basic statistical indicators such as the mean, standard deviation, and variance of the data to understand the distribution and trends of the data. Additionally, the analysis unit uses regression analysis to clarify the relationships between multiple variables, such as the relationship between sales and advertising expenses or the relationship between customer satisfaction and repurchase rate. Furthermore, the analysis unit uses data mining technology to discover useful patterns and rules from large amounts of data to aid business decision-making. For example, the analysis unit analyzes customer data to identify which products are preferred by specific customer segments and uses this information to plan marketing strategies. The analysis unit visually displays these analysis results as graphs or charts to make them intuitively understandable for the user. For example, the analysis unit automatically generates a line graph showing sales trends or a histogram showing the distribution of customer satisfaction. Additionally, the analysis unit can use AI to integrate past data and external data sources to predict future trends and risks. This allows the analysis unit to provide valuable information for understanding the current state of the business and planning future strategies through data analysis.

The generation unit generates responses to inquiries based on the analysis results obtained by the analysis unit. The generation unit generates appropriate responses to inquiries about product specifications and prices based on a pre-learned database. The generation unit can use generation AI to generate responses quickly and accurately. Specifically, the generation AI uses natural language processing technology to analyze the content of inquiries from users and generate appropriate responses. For example, when a user inquires about product specifications, the generation AI searches the product database for relevant information and generates a response in an appropriate format. Additionally, for inquiries about prices, the generation AI provides accurate responses based on the latest price information. Furthermore, the generation unit learns from the user's past inquiry history and the inquiry patterns of other users to provide more appropriate responses. For example, if there have been multiple similar inquiries, the generation AI learns the pattern and can respond quickly to future inquiries. This allows the generation unit to provide quick and accurate responses to user inquiries, thereby improving work efficiency.

The provision unit provides the responses generated by the generation unit. The provision unit provides the generated responses quickly and accurately. The provision unit can also use generation AI to provide responses. For example, the provision unit provides the generated responses through web applications or mobile applications. Specifically, the provision unit displays the generated responses in real-time through web portals or mobile applications accessed by users. Additionally, the provision unit can customize the format and display method of the responses according to the user's preferences. For example, the provision unit can provide not only text-based responses but also visual responses using graphs and charts. Furthermore, the provision unit can collect user feedback to continuously improve the accuracy and provision method of the responses. For example, users can leave evaluations or comments on the provided responses, and the provision unit updates the learning data of the generation AI based on this feedback to improve the accuracy of future responses. This allows the provision unit to provide quick and accurate responses to users, thereby improving work efficiency.

The input unit can input data using a presentation tool or a spreadsheet tool. Presentation tools may include, for example, Microsoft PowerPoint or Google Slides. Spreadsheet tools may include, for example, Microsoft Excel or Google Sheets. The input unit inputs data using, for example, a presentation tool. For example, the input unit can input data in slide format using PowerPoint. Additionally, the input unit can input data using a spreadsheet tool. For example, the input unit can input data in table format using Excel. This improves the efficiency of data input by using presentation tools or spreadsheet tools. Some or all of the aforementioned processes in the input unit may be performed using AI or without using AI. For example, the input unit can input data entered using presentation tools or spreadsheet tools into AI and have the AI perform data analysis and processing.

The creation unit can select an appropriate layout or design based on the input data and create visually comprehensible documents. The creation unit uses generation AI to select an appropriate layout or design based on the input data and create visually comprehensible documents. For example, the creation unit can automate the creation of sales reports or presentation materials. The generation AI selects an appropriate layout or design based on the input data to create visually comprehensible documents. For example, the generation AI extracts important parts of the data and creates documents based on them. The generation AI uses text generation AI (e.g., LLM) to create documents. Additionally, the generation AI can use multimodal generation AI to create the content of documents. For example, the generation AI uses keyword extraction technology to pick up particularly important information in the data and create documents based on it. This allows the automatic creation of visually comprehensible documents, improving the efficiency of document creation. Some or all of the aforementioned processes in the creation unit are performed using generation AI. For example, the creation unit can input the input data into the generation AI and have the generation AI perform document creation.

The analysis unit can analyze sales data or customer data and extract trends or patterns. The analysis unit analyzes sales data or customer data to extract trends or patterns. Sales data may include, for example, monthly sales, sales by product, etc. Customer data may include, for example, customer attribute information, purchase history, etc. The analysis unit analyzes sales data to extract trends or patterns. For example, the analysis unit can analyze sales data to analyze sales increase or decrease trends. Additionally, the analysis unit can analyze customer data to extract trends or patterns. For example, the analysis unit can analyze customer data to analyze customer purchase trends. This allows the automation of sales data or customer data analysis, improving the efficiency of trend or pattern extraction. Some or all of the aforementioned processes in the analysis unit may be performed using AI or without using AI. For example, the analysis unit can input sales data or customer data into AI and have the AI perform data analysis.

The generation unit can generate responses to inquiries about product specifications or prices based on a pre-learned database. The generation unit generates responses to inquiries about product specifications or prices based on a pre-learned database. The pre-learned database may include, for example, machine learning models or training datasets. Product specifications or prices may include, for example, technical specifications or price lists. The generation unit generates responses to inquiries about product specifications based on technical specifications. Additionally, the generation unit can generate responses to inquiries about prices based on price lists. This allows the provision of quick and accurate responses to inquiries about product specifications or prices. Some or all of the aforementioned processes in the generation unit are performed using generation AI. For example, the generation unit can input the pre-learned database into the generation AI and have the generation AI perform the generation of responses to inquiries.

The provision unit can provide the generated responses quickly and accurately. The provision unit provides the generated responses quickly and accurately. Providing quickly and accurately includes, for example, criteria such as response time or error rate. The provision unit provides the generated responses through web applications or mobile applications. For example, the provision unit displays the generated responses on a web application for user access. Additionally, the provision unit can display the generated responses on a mobile application for user access via smartphones or tablets. This improves the efficiency of inquiry response by providing the generated responses quickly and accurately. Some or all of the aforementioned processes in the provision unit may be performed using AI or without using AI. For example, the provision unit can input the generated responses into AI and have the AI perform the provision of responses.

The input unit can estimate the user's emotions and adjust the timing of data input based on the estimated emotions. The input unit, for example, delays the timing of data input when the user feels stressed, allowing input in a relaxed state. Additionally, the input unit advances the timing of data input when the user is focused, allowing efficient input. Furthermore, the input unit adjusts the timing of data input when the user is tired, allowing input with breaks. This allows the adjustment of data input timing based on the user's emotions, reducing user stress and enabling efficient data input. Emotion estimation is realized using, for example, an emotion engine or generation AI with emotion estimation functions. Generation AI may include text generation AI (e.g., LLM) or multimodal generation AI, but is not limited to these examples. Some or all of the aforementioned processes in the input unit may be performed using AI or without using AI. For example, the input unit can input the user's emotion data into the generation AI and have the generation AI perform the adjustment of data input timing.

The input unit can analyze the user's past data input history and select an input method. The input unit, for example, preferentially proposes frequently used input methods (voice input, text input, etc.) by the user in the past. Additionally, the input unit can propose the optimal input method for specific time periods based on the user's past data input history. Furthermore, the input unit can propose efficient data input procedures based on the user's past input history. This allows the proposal of the optimal input method by analyzing the user's past data input history, improving the efficiency of data input. Some or all of the aforementioned processes in the input unit may be performed using AI or without using AI. For example, the input unit can input the user's past data input history into AI and have the AI perform the selection of input methods.

The input unit can filter data based on the user's current project or area of interest during data input. The input unit, for example, prioritizes the input of data related to the project the user is currently working on. Additionally, the input unit can filter and input data with high relevance based on the user's area of interest. Furthermore, the input unit can select and input necessary data according to the progress of the user's project. This allows the efficient input of relevant data by filtering data based on the user's current project or area of interest. Some or all of the aforementioned processes in the input unit may be performed using AI or without using AI. For example, the input unit can input data related to the user's current project or area of interest into AI and have the AI perform the filtering.

The input unit can estimate the user's emotions and determine the priority of data to be input based on the estimated emotions. The input unit, for example, postpones less important data and prioritizes the input of more important data when the user feels stressed. Additionally, the input unit can input all data equally when the user is relaxed. Furthermore, the input unit can prioritize the input of the most important data when the user is in a hurry. This allows the prioritization of important data by determining the priority of data based on the user's emotions. Emotion estimation is realized using, for example, an emotion engine or generation AI with emotion estimation functions. Generation AI may include text generation AI (e.g., LLM) or multimodal generation AI, but is not limited to these examples. Some or all of the aforementioned processes in the input unit may be performed using AI or without using AI. For example, the input unit can input the user's emotion data into the generation AI and have the generation AI perform the determination of data priority.

The input unit can prioritize the input of relevant data based on the user's geographical location during data input. The input unit, for example, prioritizes the input of data related to a specific region when the user is in that region. Additionally, the input unit can input relevant data based on the current location when the user is on the move. Furthermore, the input unit can prioritize the input of data related to a specific place when the user is in that place. This allows the efficient input of relevant data by considering the user's geographical location. Some or all of the aforementioned processes in the input unit may be performed using AI or without using AI. For example, the input unit can input the user's geographical location into AI and have the AI perform the selection of relevant data.

The input unit can input related data based on the user's social media activities during data input. The input unit, for example, inputs related data based on information shared by the user on social media. Additionally, the input unit can input data related to topics of interest based on the user's social media activities. Furthermore, the input unit can analyze the activities of the user's social media followers or friends and input related data. This allows the efficient input of relevant data by analyzing the user's social media activities. Some or all of the aforementioned processes in the input unit may be performed using AI or without using AI. For example, the input unit can input the user's social media activity data into AI and have the AI perform the selection of related data.

The creation unit can estimate the user's emotions and adjust the expression method of documents based on the estimated emotions. The creation unit uses generation AI to estimate the user's emotions and adjust the expression method of documents based on the estimated emotions. For example, the creation unit creates colorful and visually appealing documents when the user is relaxed. Additionally, the creation unit can create simple and concise documents when the user is in a hurry. Furthermore, the creation unit can create documents with calming colors to visually reduce stress when the user feels stressed. This allows the creation of visually appealing documents by adjusting the expression method of documents based on the user's emotions. Emotion estimation is realized using, for example, an emotion engine or generation AI with emotion estimation functions. Generation AI may include text generation AI (e.g., LLM) or multimodal generation AI, but is not limited to these examples. Some or all of the aforementioned processes in the creation unit are performed using generation AI. For example, the creation unit can input the user's emotion data into the generation AI and have the generation AI perform the adjustment of the expression method of documents.

The creation unit can adjust the level of detail of documents based on the importance of the data during document creation. The creation unit uses generation AI to adjust the level of detail of documents based on the importance of the data during document creation. For example, the creation unit creates documents with detailed explanations and graphs for highly important data. Additionally, the creation unit can create documents with concise explanations and only key points for less important data. Furthermore, the creation unit can adjust the number of pages and the level of detail of the content of documents according to the importance of the data. This allows efficient document creation by adjusting the level of detail of documents based on the importance of the data. Some or all of the aforementioned processes in the creation unit are performed using generation AI. For example, the creation unit can input the importance of the data into the generation AI and have the generation AI perform the adjustment of the level of detail of documents.

The creation unit can apply different layouts or designs based on the category of the data during document creation. The creation unit uses generation AI to apply different layouts or designs based on the category of the data during document creation. For example, the creation unit applies a layout with many graphs and charts for sales data. Additionally, the creation unit can apply a table format layout for customer data. Furthermore, the creation unit can apply a timeline format layout for project progress data. This allows the creation of visually comprehensible documents by adjusting the layout or design according to the category of the data. Some or all of the aforementioned processes in the creation unit are performed using generation AI. For example, the creation unit can input the category of the data into the generation AI and have the generation AI perform the application of layouts or designs.

The creation unit can estimate the user's emotions and adjust the length of documents based on the estimated emotions. The creation unit uses generation AI to estimate the user's emotions and adjust the length of documents based on the estimated emotions. For example, the creation unit creates short and concise documents when the user is in a hurry. Additionally, the creation unit can create longer documents with detailed explanations when the user is relaxed. Furthermore, the creation unit can create documents of moderate length to visually reduce stress when the user feels stressed. This allows efficient document creation by adjusting the length of documents based on the user's emotions. Emotion estimation is realized using, for example, an emotion engine or generation AI with emotion estimation functions. Generation AI may include text generation AI (e.g., LLM) or multimodal generation AI, but is not limited to these examples. Some or all of the aforementioned processes in the creation unit are performed using generation AI. For example, the creation unit can input the user's emotion data into the generation AI and have the generation AI perform the adjustment of the length of documents.

The creation unit can determine the priority of documents based on the submission timing of the data during document creation. The creation unit uses generation AI to determine the priority of documents based on the submission timing of the data during document creation. For example, the creation unit prioritizes the creation of documents for data with a close deadline. Additionally, the creation unit can postpone the creation of documents for data with a distant submission timing. Furthermore, the creation unit can adjust the schedule of document creation according to the submission timing. This allows efficient document creation by determining the priority of documents based on the submission timing of the data. Some or all of the aforementioned processes in the creation unit are performed using generation AI. For example, the creation unit can input the submission timing of the data into the generation AI and have the generation AI perform the determination of document priority.

The creation unit can adjust the order of documents based on the relevance of the data during document creation. The creation unit uses generation AI to adjust the order of documents based on the relevance of the data during document creation. For example, the creation unit prioritizes the placement of highly relevant data in the first half of the documents. Additionally, the creation unit can place less relevant data in the latter half of the documents. Furthermore, the creation unit can adjust the chapters or sections of the documents according to the relevance of the data. This allows the creation of visually comprehensible documents by adjusting the order of documents based on the relevance of the data. Some or all of the aforementioned processes in the creation unit are performed using generation AI. For example, the creation unit can input the relevance of the data into the generation AI and have the generation AI perform the adjustment of document order.

The analysis unit can estimate the user's emotions and adjust the analysis criteria based on the estimated emotions. The analysis unit uses AI to estimate the user's emotions and adjust the analysis criteria based on the estimated emotions. For example, the analysis unit applies detailed analysis criteria when the user is relaxed. Additionally, the analysis unit can apply concise analysis criteria when the user is in a hurry. Furthermore, the analysis unit can apply analysis criteria to visually reduce stress when the user feels stressed. This allows efficient data analysis by adjusting the analysis criteria based on the user's emotions. Emotion estimation is realized using, for example, an emotion engine or generation AI with emotion estimation functions. Generation AI may include text generation AI (e.g., LLM) or multimodal generation AI, but is not limited to these examples. Some or all of the aforementioned processes in the analysis unit are performed using AI. For example, the analysis unit can input the user's emotion data into the generation AI and have the generation AI perform the adjustment of analysis criteria.

The analysis unit can improve the accuracy of analysis based on the interrelationships of the data during analysis. The analysis unit uses AI to improve the accuracy of analysis by considering the interrelationships of the data during analysis. For example, the analysis unit considers the interrelationship between sales data and customer data to extract trends. Additionally, the analysis unit can propose efficient resource allocation by considering the interrelationship between project progress data and resource data. Furthermore, the analysis unit can analyze market trends by considering the interrelationship between product data and market data. This improves the accuracy of analysis by considering the interrelationships of the data. Some or all of the aforementioned processes in the analysis unit may be performed using AI or without using AI. For example, the analysis unit can input the interrelationships of the data into AI and have the AI perform the improvement of analysis accuracy.

The analysis unit can perform analysis based on the geographical distribution of the data during analysis. The analysis unit uses AI to perform analysis by considering the geographical distribution of the data during analysis. For example, the analysis unit considers the geographical distribution of sales data to analyze trends by region. Additionally, the analysis unit can analyze customer characteristics by region by considering the geographical distribution of customer data. Furthermore, the analysis unit can analyze market needs by region by considering the geographical distribution of product data. This allows analysis that reflects regional characteristics by considering the geographical distribution of the data. Some or all of the aforementioned processes in the analysis unit may be performed using AI or without using AI. For example, the analysis unit can input the geographical distribution of the data into AI and have the AI perform the analysis.

The analysis unit can improve the accuracy of analysis by referring to related literature of the data during analysis. The analysis unit uses AI to improve the accuracy of analysis by referring to related literature of the data during analysis. For example, the analysis unit refers to related market research reports during the analysis of sales data. Additionally, the analysis unit can refer to related academic papers during the analysis of customer data. Furthermore, the analysis unit can refer to related technical literature during the analysis of product data. This improves the accuracy of analysis by referring to related literature of the data. Some or all of the aforementioned processes in the analysis unit may be performed using AI or without using AI. For example, the analysis unit can input the related literature of the data into AI and have the AI perform the improvement of analysis accuracy.

The generation unit can estimate the user's emotions and adjust the method of generating responses based on the estimated emotions. The generation unit uses AI to estimate the user's emotions and adjust the method of generating responses based on the estimated emotions. For example, the generation unit generates detailed responses when the user is relaxed. Additionally, the generation unit can generate concise and to-the-point responses when the user is in a hurry. Furthermore, the generation unit can generate responses to visually reduce stress when the user feels stressed. This allows the provision of more appropriate responses by adjusting the method of generating responses based on the user's emotions. Emotion estimation is realized using, for example, an emotion engine or generation AI with emotion estimation functions. Generation AI may include text generation AI (e.g., LLM) or multimodal generation AI, but is not limited to these examples. Some or all of the aforementioned processes in the generation unit are performed using AI. For example, the generation unit can input the user's emotion data into the generation AI and have the generation AI perform the adjustment of the method of generating responses.

The generation unit can generate responses based on past inquiry data during response generation. The generation unit uses AI to generate optimal responses by referring to past inquiry data during response generation. For example, the generation unit generates optimal responses based on past responses when there have been similar inquiries. Additionally, the generation unit can generate responses to frequently asked questions based on past inquiry data. Furthermore, the generation unit can analyze past inquiry data to generate the most effective responses. This allows the quick generation of optimal responses by referring to past inquiry data. Some or all of the aforementioned processes in the generation unit may be performed using AI or without using AI. For example, the generation unit can input past inquiry data into AI and have the AI perform the generation of responses.

The generation unit can apply response algorithms based on the category of the inquiry during response generation. The generation unit uses AI to apply different response algorithms according to the category of the inquiry during response generation. For example, the generation unit applies a response algorithm including technical details for inquiries about product specifications. Additionally, the generation unit can apply a response algorithm including price lists or discount information for inquiries about prices. Furthermore, the generation unit can apply a response algorithm including procedures or FAQs for inquiries about support. This allows the provision of optimal responses according to the category of the inquiry. Some or all of the aforementioned processes in the generation unit may be performed using AI or without using AI. For example, the generation unit can input the category of the inquiry into AI and have the AI perform the application of response algorithms.

The generation unit can estimate the user's emotions and determine the priority of responses based on the estimated emotions. The generation unit uses AI to estimate the user's emotions and determine the priority of responses based on the estimated emotions. For example, the generation unit prioritizes the provision of the most important responses when the user is in a hurry. Additionally, the generation unit can prioritize the provision of detailed responses when the user is relaxed. Furthermore, the generation unit can prioritize the provision of responses to visually reduce stress when the user feels stressed. This allows the prioritization of important responses by determining the priority of responses based on the user's emotions. Emotion estimation is realized using, for example, an emotion engine or generation AI with emotion estimation functions. Generation AI may include text generation AI (e.g., LLM) or multimodal generation AI, but is not limited to these examples. Some or all of the aforementioned processes in the generation unit are performed using AI. For example, the generation unit can input the user's emotion data into the generation AI and have the generation AI perform the determination of response priority.

The generation unit can determine the priority of responses based on the submission timing of the inquiry during response generation. The generation unit uses AI to determine the priority of responses based on the submission timing of the inquiry during response generation. For example, the generation unit generates responses quickly for urgent inquiries. Additionally, the generation unit can postpone the generation of responses for inquiries with an old submission timing. Furthermore, the generation unit can adjust the schedule of response generation according to the submission timing. This allows quick response by determining the priority of responses based on the submission timing of the inquiry. Some or all of the aforementioned processes in the generation unit may be performed using AI or without using AI. For example, the generation unit can input the submission timing of the inquiry into AI and have the AI perform the determination of response priority.

The generation unit can adjust the order of responses based on the relevance of the inquiry during response generation. The generation unit uses AI to adjust the order of responses based on the relevance of the inquiry during response generation. For example, the generation unit prioritizes the generation of responses for highly relevant inquiries. Additionally, the generation unit can postpone the generation of responses for less relevant inquiries. Furthermore, the generation unit can adjust the order of responses according to the relevance of the inquiry. This allows efficient response provision by adjusting the order of responses based on the relevance of the inquiry. Some or all of the aforementioned processes in the generation unit may be performed using AI or without using AI. For example, the generation unit can input the relevance of the inquiry into AI and have the AI perform the adjustment of response order.

The provision unit can estimate the user's emotions and adjust the method of providing responses based on the estimated emotions. The provision unit uses AI to estimate the user's emotions and adjust the method of providing responses based on the estimated emotions. For example, the provision unit provides responses with detailed explanations when the user is relaxed. Additionally, the provision unit can provide concise and to-the-point responses when the user is in a hurry. Furthermore, the provision unit can provide responses to visually reduce stress when the user feels stressed. This allows the provision of more appropriate responses by adjusting the method of providing responses based on the user's emotions. Emotion estimation is realized using, for example, an emotion engine or generation AI with emotion estimation functions. Generation AI may include text generation AI (e.g., LLM) or multimodal generation AI, but is not limited to these examples. Some or all of the aforementioned processes in the provision unit are performed using AI. For example, the provision unit can input the user's emotion data into the generation AI and have the generation AI perform the adjustment of the method of providing responses.

The provision unit can select the method of providing responses based on the user's past inquiry history during response provision. The provision unit uses AI to select the optimal method of providing responses by referring to the user's past inquiry history during response provision. For example, the provision unit preferentially provides the method of provision (email, chat, etc.) that the user has preferred to use in the past. Additionally, the provision unit can select the optimal method of provision based on the user's past inquiry history. Furthermore, the provision unit can select an efficient method of provision based on the user's past inquiry history. This allows the selection of the optimal method of provision by referring to the user's past inquiry history. Some or all of the aforementioned processes in the provision unit may be performed using AI or without using AI. For example, the provision unit can input the user's past inquiry history into AI and have the AI perform the selection of the method of provision.

The provision unit can estimate the user's emotions and adjust the order of providing responses based on the estimated emotions. The provision unit uses AI to estimate the user's emotions and adjust the order of providing responses based on the estimated emotions. For example, the provision unit prioritizes the provision of detailed responses when the user is relaxed. Additionally, the provision unit can prioritize the provision of the most important responses when the user is in a hurry. Furthermore, the provision unit can prioritize the provision of responses to visually reduce stress when the user feels stressed. This allows the prioritization of important responses by adjusting the order of providing responses based on the user's emotions. Emotion estimation is realized using, for example, an emotion engine or generation AI with emotion estimation functions. Generation AI may include text generation AI (e.g., LLM) or multimodal generation AI, but is not limited to these examples. Some or all of the aforementioned processes in the provision unit are performed using AI. For example, the provision unit can input the user's emotion data into the generation AI and have the generation AI perform the adjustment of the order of providing responses.

The provision unit can select the method of providing responses based on the user's device information during response provision. The provision unit uses AI to select the optimal method of providing responses by considering the user's device information during response provision. For example, the provision unit selects a method of provision that matches the screen size when the user is using a smartphone. Additionally, the provision unit can select a method of provision optimized for a large screen when the user is using a tablet. Furthermore, the provision unit can select a method of provision that includes detailed information when the user is using a desktop. This allows the selection of the optimal method of provision by considering the user's device information. Some or all of the aforementioned processes in the provision unit may be performed using AI or without using AI. For example, the provision unit can input the user's device information into AI and have the AI perform the selection of the method of provision.

The system according to the embodiment is not limited to the examples described above and can be modified in various ways, for example, as follows.

The office work efficiency system further comprises a notification unit. The notification unit plays a role in notifying the user of the processing results from the creation unit, analysis unit, or generation unit. For example, when the creation unit completes a document, the notification unit can send a notification to the user via email or chat. Additionally, when the analysis unit discovers a new trend, the notification unit can inform the user of the result in real-time. Furthermore, when the generation unit generates a response to an inquiry, the notification unit can quickly provide the response to the user. This allows the user to receive important information in a timely manner, further improving work efficiency.

The input unit can analyze the user's past data input history and select an input method. For example, the input unit preferentially proposes frequently used input methods (voice input, text input, etc.) by the user in the past. Additionally, the input unit can propose the optimal input method for specific time periods based on the user's past data input history. Furthermore, the input unit can propose efficient data input procedures based on the user's past input history. This allows the proposal of the optimal input method by analyzing the user's past data input history, improving the efficiency of data input.

The creation unit can adjust the level of detail of documents based on the importance of the data during document creation. For example, the creation unit creates documents with detailed explanations and graphs for highly important data. Additionally, the creation unit can create documents with concise explanations and only key points for less important data. Furthermore, the creation unit can adjust the number of pages and the level of detail of the content of documents according to the importance of the data. This allows efficient document creation by adjusting the level of detail of documents based on the importance of the data.

The analysis unit can improve the accuracy of analysis based on the interrelationships of the data during analysis. For example, the analysis unit considers the interrelationship between sales data and customer data to extract trends. Additionally, the analysis unit can propose efficient resource allocation by considering the interrelationship between project progress data and resource data. Furthermore, the analysis unit can analyze market trends by considering the interrelationship between product data and market data. This improves the accuracy of analysis by considering the interrelationships of the data.

The generation unit can generate responses based on past inquiry data during response generation. For example, the generation unit generates optimal responses based on past responses when there have been similar inquiries. Additionally, the generation unit can generate responses to frequently asked questions based on past inquiry data. Furthermore, the generation unit can analyze past inquiry data to generate the most effective responses. This allows the quick generation of optimal responses by referring to past inquiry data.

The input unit can estimate the user's emotions and adjust the timing of data input based on the estimated emotions. For example, the input unit delays the timing of data input when the user feels stressed, allowing input in a relaxed state. Additionally, the input unit advances the timing of data input when the user is focused, allowing efficient input. Furthermore, the input unit adjusts the timing of data input when the user is tired, allowing input with breaks. This allows the adjustment of data input timing based on the user's emotions, reducing user stress and enabling efficient data input.

The creation unit can estimate the user's emotions and adjust the expression method of documents based on the estimated emotions. For example, the creation unit creates colorful and visually appealing documents when the user is relaxed. Additionally, the creation unit can create simple and concise documents when the user is in a hurry. Furthermore, the creation unit can create documents with calming colors to visually reduce stress when the user feels stressed. This allows the creation of visually appealing documents by adjusting the expression method of documents based on the user's emotions.

The analysis unit can estimate the user's emotions and adjust the analysis criteria based on the estimated emotions. For example, the analysis unit applies detailed analysis criteria when the user is relaxed. Additionally, the analysis unit can apply concise analysis criteria when the user is in a hurry. Furthermore, the analysis unit can apply analysis criteria to visually reduce stress when the user feels stressed. This allows efficient data analysis by adjusting the analysis criteria based on the user's emotions.

The generation unit can estimate the user's emotions and adjust the method of generating responses based on the estimated emotions. For example, the generation unit generates detailed responses when the user is relaxed. Additionally, the generation unit can generate concise and to-the-point responses when the user is in a hurry. Furthermore, the generation unit can generate responses to visually reduce stress when the user feels stressed. This allows the provision of more appropriate responses by adjusting the method of generating responses based on the user's emotions.

The provision unit can estimate the user's emotions and adjust the method of providing responses based on the estimated emotions. For example, the provision unit provides responses with detailed explanations when the user is relaxed. Additionally, the provision unit can provide concise and to-the-point responses when the user is in a hurry. Furthermore, the provision unit can provide responses to visually reduce stress when the user feels stressed. This allows the provision of more appropriate responses by adjusting the method of providing responses based on the user's emotions.

The following is a brief explanation of the process flow in Example 2 of the Embodiment.

Step 1: The input unit inputs data. The data may include, for example, text data, numerical data, image data, etc. The input unit inputs data using presentation tools (e.g., Microsoft PowerPoint, Google Slides) or spreadsheet tools (e.g., Microsoft Excel, Google Sheets).

Step 2: The creation unit uses generation AI to create documents based on the data input by the input unit. Documents may include reports, presentation materials, analysis reports, etc. The creation unit selects appropriate layouts and designs based on the input data to create visually comprehensible documents. The generation AI uses text generation AI (e.g., LLM) to create documents and can also extract important parts of the data to create documents.

Step 3: The analysis unit analyzes numerical values based on the data input by the input unit. Numerical analysis may include statistical analysis, regression analysis, data mining, etc. The analysis unit analyzes sales data and customer data to extract trends and patterns. The analysis unit uses complex formulas and statistical methods to analyze the data and outputs the results as graphs or charts.

Step 4: The generation unit generates responses to inquiries based on the analysis results obtained by the analysis unit. The generation unit generates appropriate responses to inquiries about product specifications and prices based on a pre-learned database. The generation unit uses generation AI to generate responses quickly and accurately.

Step 5: The provision unit provides the responses generated by the generation unit. The provision unit provides the generated responses quickly and accurately. The provision unit uses generation AI to provide responses through web applications or mobile applications.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the multiple elements including the aforementioned input unit, creation unit, analysis unit, generation unit, and provision unit is implemented by at least one of, for example, a smart device 14 and a data processing device 12. For example, the input unit is implemented by the input device 38 of the smart device 14 and inputs data. The creation unit is implemented by the specific processing unit 290 of the data processing device 12 and creates documents using a generation AI. The analysis unit is implemented by the specific processing unit 290 of the data processing device 12 and analyzes numerical values. The generation unit is implemented by the specific processing unit 290 of the data processing device 12 and generates responses to inquiries. The provision unit is implemented by the output device 40 of the smart device 14 and provides the generated responses. The correspondence between each unit and the devices or control units is not limited to the examples described above, and various modifications are possible.

### Second Embodiment

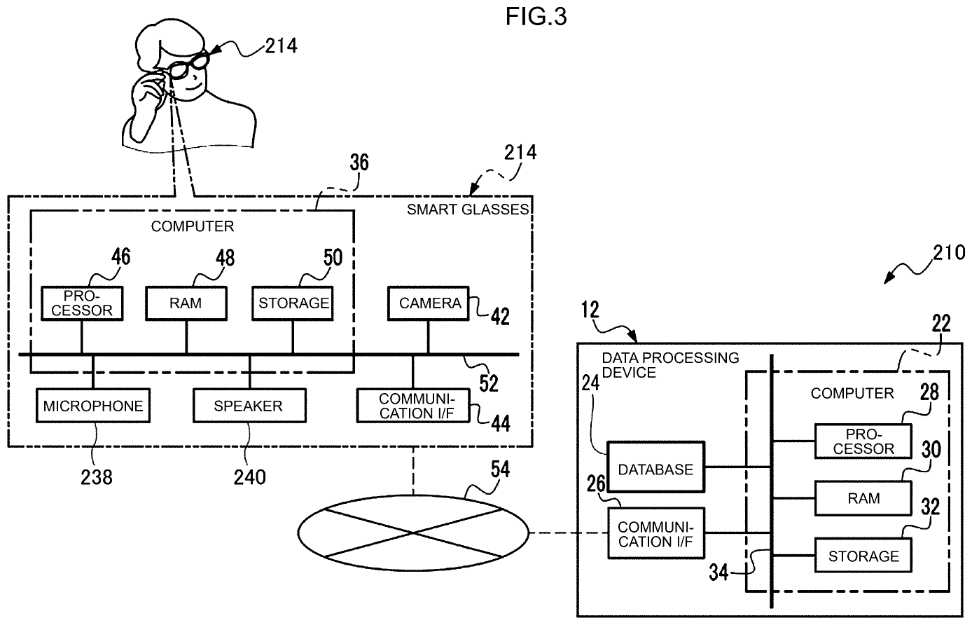

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

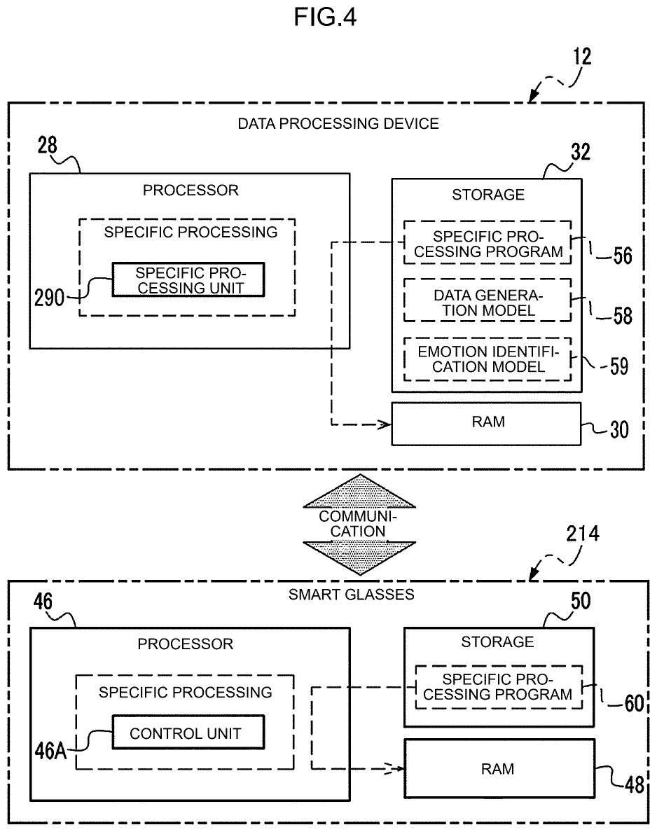

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the multiple elements including the aforementioned input unit, creation unit, analysis unit, generation unit, and provision unit is implemented by at least one of, for example, smart glasses 214 and a data processing device 12. For example, the input unit is implemented by the microphone 238 of the smart glasses 214 and inputs data. The creation unit is implemented by the specific processing unit 290 of the data processing device 12 and creates documents using a generation AI. The analysis unit is implemented by the specific processing unit 290 of the data processing device 12 and analyzes numerical values. The generation unit is implemented by the specific processing unit 290 of the data processing device 12 and generates responses to inquiries. The provision unit is implemented by the speaker 240 of the smart glasses 214 and provides the generated responses. The correspondence between each unit and the devices or control units is not limited to the examples described above, and various modifications are possible.

### Third Embodiment

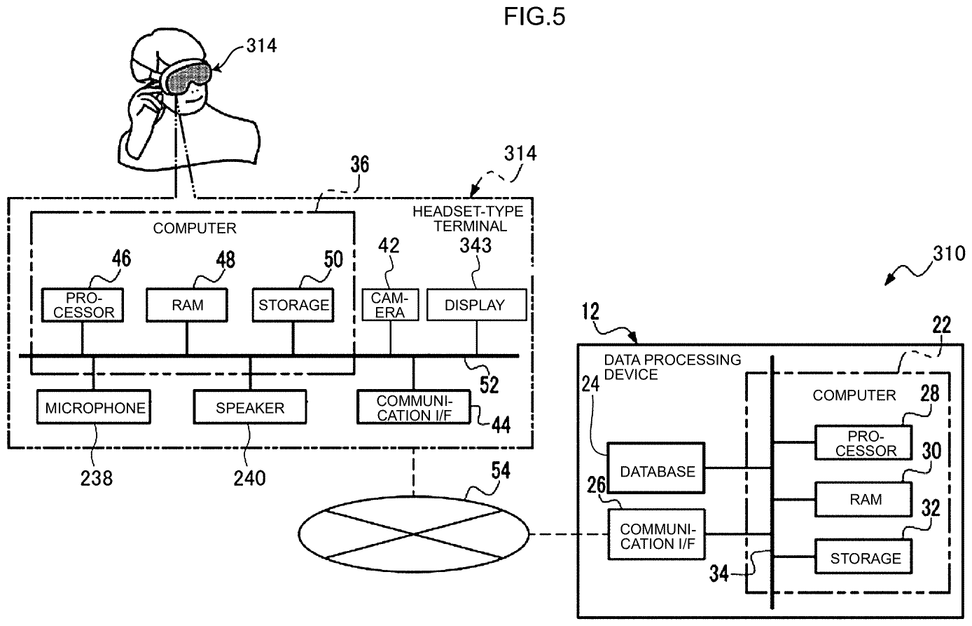

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

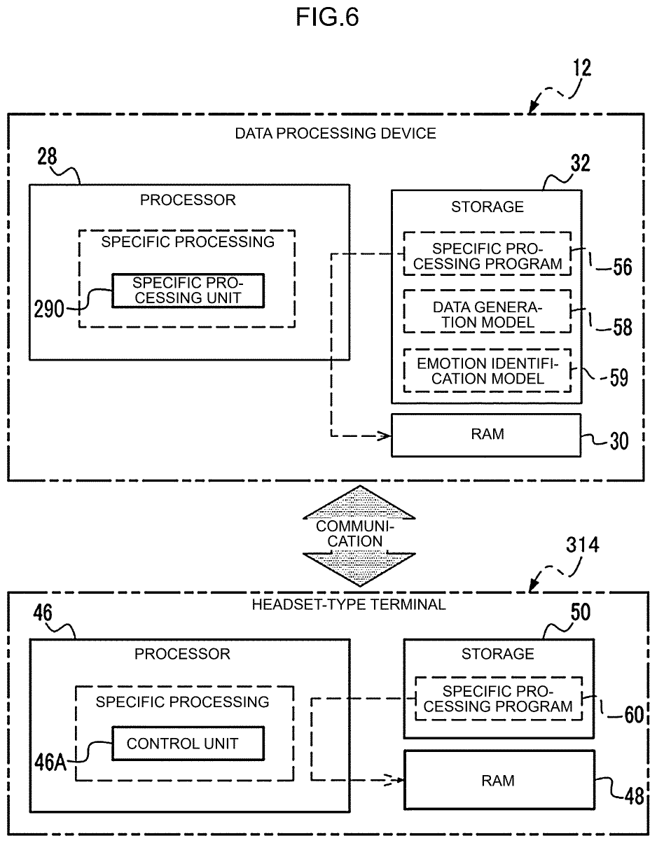

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices. Each of the multiple elements including the aforementioned input unit, creation unit, analysis unit, generation unit, and provision unit is implemented by at least one of, for example, a headset-type terminal 314 and a data processing device 12. For example, the input unit is implemented by the microphone 238 of the headset-type terminal 314 and inputs data. The creation unit is implemented by the specific processing unit 290 of the data processing device 12 and creates documents using a generation AI. The analysis unit is implemented by the specific processing unit 290 of the data processing device 12 and analyzes numerical values. The generation unit is implemented by the specific processing unit 290 of the data processing device 12 and generates responses to inquiries. The provision unit is implemented by the display 343 of the headset-type terminal 314 and provides the generated responses. The correspondence between each unit and the devices or control units is not limited to the examples described above, and various modifications are possible.

### Fourth Embodiment

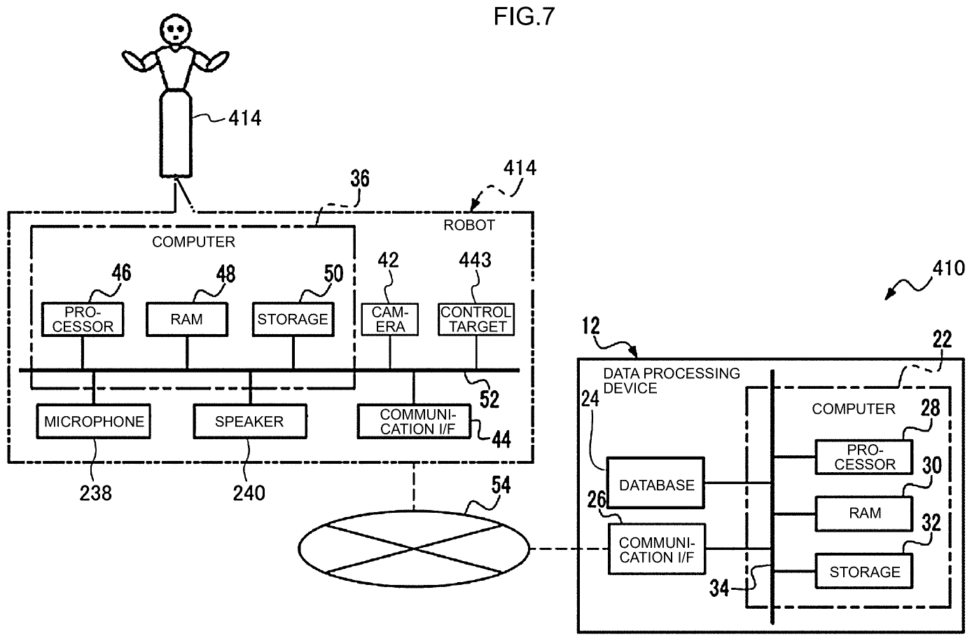

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

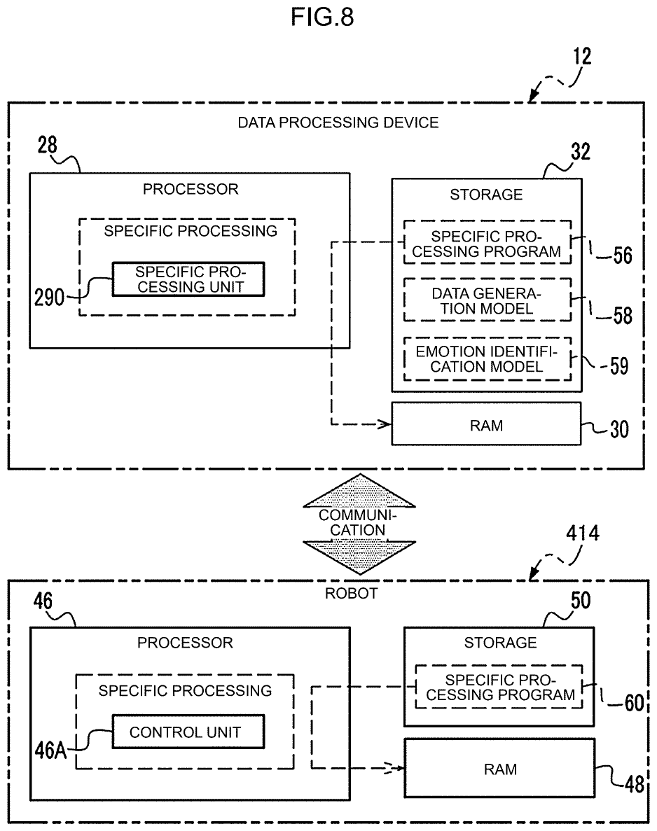

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the multiple elements including the aforementioned input unit, creation unit, analysis unit, generation unit, and provision unit is implemented by at least one of, for example, a robot 414 and a data processing device 12. For example, the input unit is implemented by the microphone 238 of the robot 414 and inputs data. The creation unit is implemented by the specific processing unit 290 of the data processing device 12 and creates documents using a generation AI. The analysis unit is implemented by the specific processing unit 290 of the data processing device 12 and analyzes numerical values. The generation unit is implemented by the specific processing unit 290 of the data processing device 12 and generates responses to inquiries. The provision unit is implemented by the speaker 240 of the robot 414 and provides the generated responses. The correspondence between each unit and the devices or control units is not limited to the examples described above, and various modifications are possible.

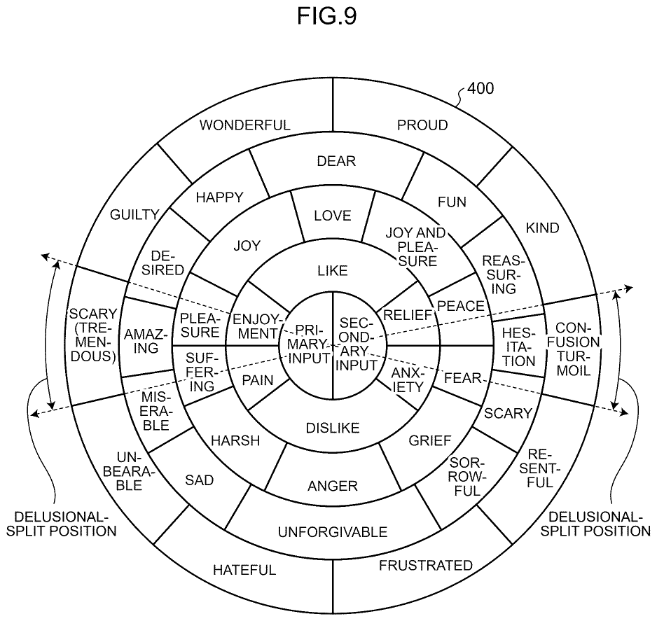

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o′clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

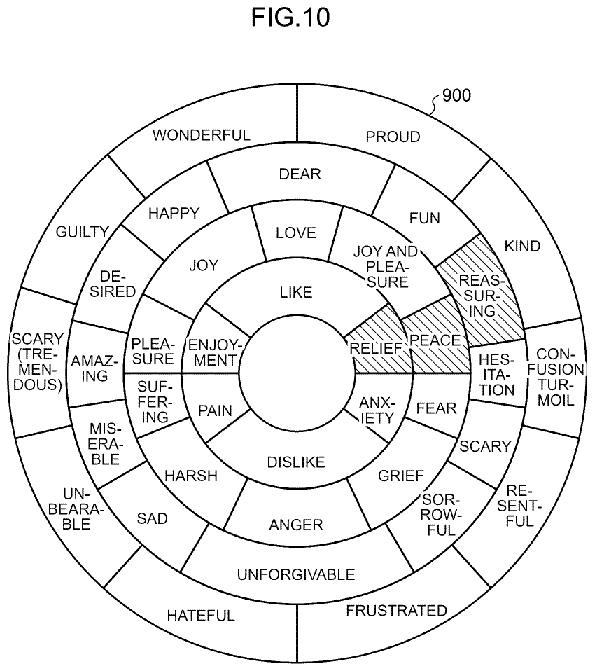

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used. Additionally, the examples described above were explained by dividing into form example 1 and form example 2, but these may be combined.

The system according to the embodiment can automate operations such as material creation, numerical analysis, and inquiry response, thereby improving efficiency.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

### Additional Note 1

A system including:
an input unit that inputs data;
a creation unit that creates a document based on the data input by the input unit;
an analysis unit that analyzes a numerical value based on the document created by the creation unit;
a generation unit that generates a response to an inquiry based on an analysis result obtained by the analysis unit; and
a provision unit that provides the response generated by the generation unit.

### Additional Note 2

The system according to Additional Note 1, wherein the input unit inputs data using a presentation tool or a spreadsheet tool.

### Additional Note 3

The system according to Additional Note 1, wherein the creation unit selects an appropriate layout or design based on the input data, and creates a visually comprehensible document.

### Additional Note 4

The system according to Additional Note 1, wherein the analysis unit analyzes sales data or customer data, and extracts a trend or a pattern.

### Additional Note 5

The system according to Additional Note 1, wherein the generation unit generates a response to an inquiry about a product specification or price based on a pre-learned database.

### Additional Note 6

The system according to Additional Note 1, wherein the provision unit provides the generated response quickly and accurately.

### Additional Note 7

The system according to Additional Note 1, wherein the input unit estimates user's emotions, and adjusts a timing of data input based on the estimated emotions.

### Additional Note 8

The system according to Additional Note 1, wherein the input unit analyzes a user's past data input history, and selects an input method.

### Additional Note 9

The system according to Additional Note 1, wherein the input unit filters data based on a user's current project or area of interest during data input.

### Additional Note 10

The system according to Additional Note 1, wherein the input unit determines a priority of data to be input based on estimated user's emotions.

### Additional Note 11

The system according to Additional Note 1, wherein the input unit prioritizes relevant data based on a user's geographical location during data input.

### Additional Note 12

The system according to Additional Note 1, wherein the input unit inputs related data based on a user's social media activity during data input.

### Additional Note 13

The system according to Additional Note 1, wherein the creation unit adjusts an expression method of documents based on the estimated user's emotions.

### Additional Note 14

The system according to Additional Note 1, wherein the creation unit adjusts the level of detail of the document based on importance of the data during document creation.

### Additional Note 15

The system according to Additional Note 1, wherein the creation unit applies different a layout or a design based on a category of the data during document creation.

### Additional Note 16

The system according to Additional Note 1, wherein the creation unit adjusts a length of document based on estimated user's emotions.

### Additional Note 17

The system according to Additional Note 1, wherein the creation unit determines a priority of the document based on a submission timing of the data during document creation.

### Additional Note 18

The system according to Additional Note 1, wherein the creation unit adjusts an order of the document based on relevance of the data during document creation.

### Additional Note 19

The system according to Additional Note 1, wherein the analysis unit adjusts an analysis criteria based on estimated user's emotions.

### Additional Note 20

The system according to Additional Note 1, wherein the analysis unit improves accuracy of analysis based on interrelationship of the data during analysis.

### Additional Note 21

The system according to Additional Note 1, wherein the analysis unit performs analysis based on geographical distribution of the data during analysis.

### Additional Note 22

The system according to Additional Note 1, wherein the analysis unit improves accuracy of analysis by referring to related literature of the data during analysis.

### Additional Note 23

The system according to Additional Note 1, wherein the generation unit adjusts a method for generating a response based on estimated user's emotions.

### Additional Note 24

The system according to Additional Note 1, wherein the generation unit generates a response based on past inquiry data during response generation.

### Additional Note 25

The system according to Additional Note 1, wherein the generation unit applies a response algorithm based on a category of an inquiry during response generation.

### Additional Note 26

The system according to Additional Note 1, wherein the generation unit determines a priority of a response based on estimated user's emotions.

### Additional Note 27

The system according to Additional Note 1, wherein the generation unit determines a priority of a response based on a submission timing of an inquiry during response generation.

### Additional Note 28

The system according to Additional Note 1, wherein the generation unit adjusts an order of a response based on relevance of an inquiry during response generation.

### Additional Note 29

The system according to Additional Note 1, wherein the provision unit adjusts a method for providing a response based on estimated user's emotions.

### Additional Note 30

The system according to Additional Note 1, wherein the provision unit selects a method for providing a response based on a user's past inquiry history during response provision.

### Additional Note 31

The system according to Additional Note 1, wherein the provision unit adjusts an order of providing response based on estimated user's emotions.

### Additional Note 32

The system according to Additional Note 1, wherein the provision unit selects a method for providing a response based on user's device information during response provision.

What is claimed is:

1. A system comprising:
an input unit that inputs data;
a creation unit that creates a document based on the data input by the input unit;
an analysis unit that analyzes a numerical value based on the document created by the creation unit;
a generation unit that generates a response to an inquiry based on an analysis result obtained by the analysis unit; and
a provision unit that provides the response generated by the generation unit.

2. The system according to claim 1, wherein the input unit inputs data using a presentation tool or a spreadsheet tool.

3. The system according to claim 1, wherein the creation unit selects an appropriate layout or design based on the input data, and creates a visually comprehensible document.

4. The system according to claim 1, wherein the analysis unit analyzes sales data or customer data, and extracts a trend or a pattern.

5. The system according to claim 1, wherein the generation unit generates a response to an inquiry about a product specification or price based on a pre-learned database.

6. The system according to claim 1, wherein the input unit estimates user's emotions, and adjusts a timing of data input based on the estimated emotions.

7. The system according to claim 1, wherein the input unit analyzes user's past data input history, and selects an input method.
